(19) United States
(12) Patent Application Publication
(10) Pub. No.: US 2008/0036189 A1
(43) Pub. Date: Feb. 14, 2008

(54) Airbag

(75) Inventor: Tobias Pausch, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/822,965

(22) Filed: Jul. 11, 2007

Related U.S. Application Data
(60) Provisional application No. 60/807,398, filed on Jul. 14, 2006.

(51) Int. Cl. B60R 21/23

(52) U.S. Cl. 280/743.1

(57) ABSTRACT

An airbag for protecting an occupant includes a left half airbag having an inner panel and a right half airbag having an inner panel. At least one outer panel is provided and a seam allowance is provided on at least one of the inner panels when the left and right inner panels are stitched together. When the airbag is inflated, the seam allowance extends into an inside part of the airbag and controls inflation of the airbag in a vertical direction.

### CROSS-REFERENCE TO RELATED PATENT APPLICATIONS

This application claims priority to and the benefit of U.S. Provisional Application Ser. No. 60/807,398, filed on Jul. 14, 2006, and entitled “Airbag.” The aforementioned provisional application is incorporated herein by reference in its entirety.

### BACKGROUND

The present application relates generally to airbags for protecting a vehicle occupant in the event of a vehicle collision. More specifically, the application relates to a twin airbag or a dual lobe shape airbag. The present application also relates to an airbag device provided with the airbag and a vehicle with the airbag device.

Conventionally, there are known airbags having two inner panels (i.e., a left inner panel and a right inner panel) and one or more outer panels for protecting vehicle occupants. For example, U.S. Patent Application Publication No. 2006-103654 discloses an airbag having two inner panels and an outer panel. The inner side edges of the inner panels are stitched together and the outer side edges of the inner panels are stitched to the outer portion of the outer panel. The length of the stitched inner side edge is smaller than the lengths of the stitched outer side edges.

When such conventional airbags are inflated, a connected portion of the stitched inner side edge does not outwardly protrude and a developing direction (i.e., the direction in the entire fabric forming the airbag) is controlled with the connected portion of the inner side panel. A concave portion is formed in a vertical direction of the airbag facing a vehicle occupant. In this case, the two inner panels are formed into identical shapes.

With the conventional airbag described above, the concave portion can be formed without a tether. However, since there is nothing to control an outer shape of the airbag, the airbag tends to inflate largely in an effort to inflate equally in the vertical, right, left and longitudinal directions. Therefore, the longitudinal lengths of the inner and outer panels must be made large in order to provide adequate inflation amounts of the airbag protruding into the vehicle occupant. Accordingly, the conventional airbag must be made large in size. Such a conventional airbag must also require an inflator with a larger output capacity in order to quickly inflate the large-sized airbag, which can increase the cost of the airbag fabric and the inflator.

Furthermore, such a conventional airbag with a concave portion formed in a central vertical direction of the airbag facing the vehicle occupant includes a small seam from which the two inner panels are stitched together. The seam allowance is set to have a minimum width because it is easy to fold the airbag and make the entire airbag module small in size with less fabric, thus improving the overall layout in the vehicle.

However, since the length of the inner side edge of the inner panels is different from the length of the outer side edges, (e.g., the inner panels are formed into a concave), the inner side of the inner panel is formed into a large concave portion. Therefore, when the airbag fabric is cut out, a large amount of fabric is wasted. In addition, since the seam allowance is made with a minimum width, the amount of fabric wasted increases further. Thus, one drawback with the conventional airbag is the high cost due to the increased amount of fabric required to cut out the airbag panels. Additional drawbacks include the difficulty in folding the airbag and the large size of the airbag module, thus resulting in a poor vehicle layout.

Accordingly, there is a need for an airbag that is compact in size and economical to manufacture.

### SUMMARY OF THE INVENTION

According to a disclosed embodiment, an airbag for protecting an occupant includes a left half airbag having an inner panel and a right half airbag having an inner panel. At least one outer panel is provided and a seam allowance is provided on at least one of the inner panels when the left and right inner panels are stitched together. When the airbag is inflated, the seam allowance extends into an inside part of the airbag and controls inflation of the airbag in a vertical direction.

### BRIEF DESCRIPTION OF THE DRAWINGS

Features, aspects and advantages of the present invention will become apparent from the following description, appended claims, and accompanying exemplary embodiments shown in the drawings, which are briefly described below.

FIG. 1 is a front view of an airbag according to one disclosed embodiment.

FIG. 2 is a view of the airbag of FIG. 1 from the direction of an inflator according to one disclosed embodiment.

FIG. 3 is a side view of the airbag of FIG. 1 according to one disclosed embodiment.

FIG. 4 is a cross-sectional view of the airbag taken along line A-A in FIG. 2.

FIG. 5 is a cross-sectional view of the airbag taken along line B-B in FIG. 3.

FIG. 6 is a top view of the outer panel prior to assembly into the airbag according to one disclosed embodiment.

FIG. 7 is a view of the left and right inner panels according to one disclosed embodiment.

FIG. 8 is a view of the inner panel assembly illustrating the sewing line joining the left and right inner panels according to one disclosed embodiment.

FIG. 9 is a side view of an airbag illustrating a seam allowance according to one disclosed embodiment.

FIG. 10 is a side view of an airbag illustrating a seam allowance according to one disclosed embodiment.

FIG. 11 is a detailed view of an airbag illustrating the seam allowance (margin area) according to one disclosed embodiment.

FIG. 12 is a view showing an airbag according to another disclosed embodiment.

FIG. 13 is a side view showing a vehicle provided with various airbag devices according to one disclosed embodiment.

### DETAILED DESCRIPTION

Embodiments will be described with reference to the accompanying drawings. It should be understood that the following description is intended to describe embodiments of the invention, and not to limit the invention.

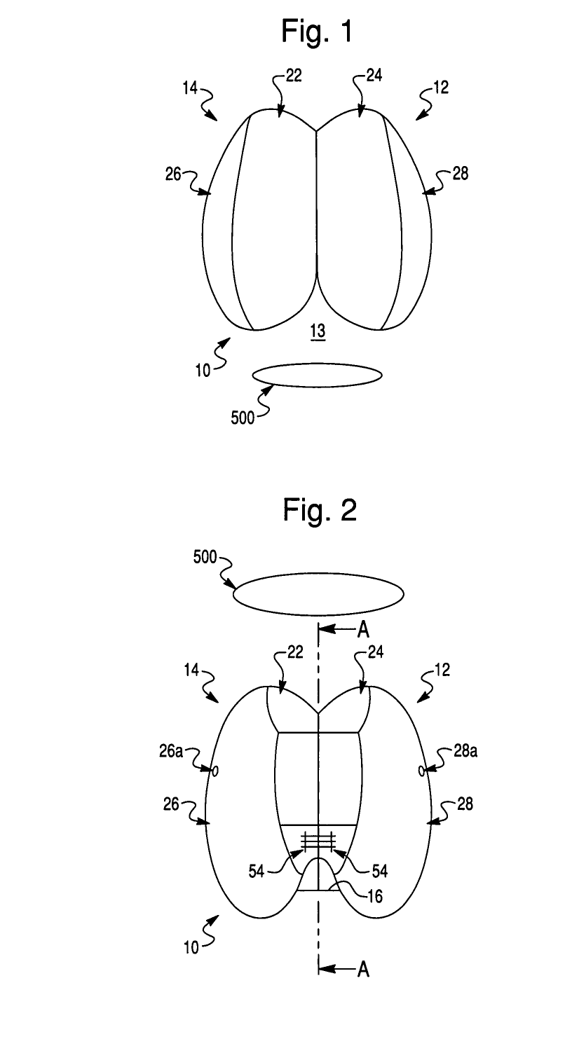

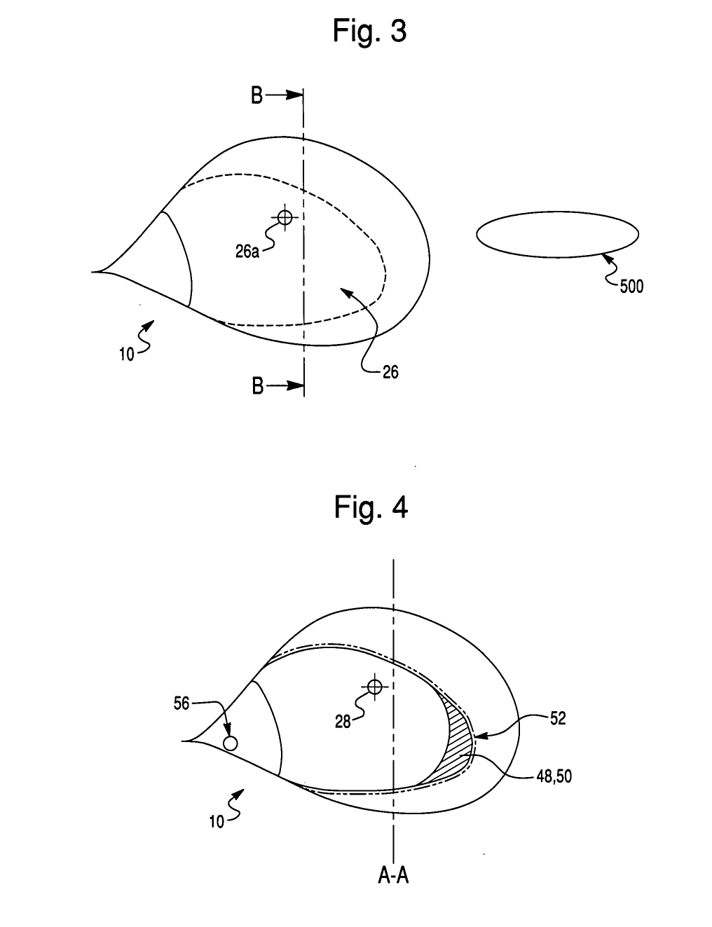

FIG. 1 is a front view of an airbag, FIG. 2 is a view of the airbag of FIG. 1 from the direction of an inflator and FIG. 3 is a side view of the airbag of FIG. 1 according to one disclosed embodiment.

An airbag 10, according to one disclosed embodiment, includes a right half airbag 12 to be inflated at a front right of a vehicle occupant 500, a left half airbag 14 to be inflated at a front left of the occupant 500, and a communicating portion 16 for communicating an end of the right half airbag 12 with an end of the left half airbag 14. As illustrated in FIG. 2, the communicating portion 16 is located at a side of a base of the airbag 10. Accordingly, the right half airbag 12 and the left half airbag 14 are inflated toward a direction that the half airbags move away from the communicating portion 16.

In the inflated state of the airbag 10, a bridge component such as a tie panel or tether does not have to be disposed between the distal ends of the right half airbag 12 and the left half airbag 14. A space 13 between the distal ends of the right half airbag 12 and the left half airbag 14 is open toward the occupant.

In the airbag 10, the right half airbag 12 is connected with the left half airbag 14 with a stitched portion 52 in a direction that the airbag is inflated. Seam allowances 48 and 50 are created by the stitched portion 52.

According to one disclosed embodiment as illustrated in FIGS. 1 and 2, the airbag 10 further includes inner and outer panels 22, 24, 26 and 28 stitched together. In particular, the right half airbag 12 includes right inner panel 24 and right outer panel 28. The left half airbag 14 includes left inner panel 22 and left outer panel 26. The outer left and right panels 26 and 28, respectively, are provided with vent holes 26a and 28a (shown in FIG. 2), respectively. As shown in FIG. 2, the vent holes 26a and 28a are formed in side surfaces of the airbags 12 and 14 facing outwardly. The vent hole 26a formed in the panel 26 is located at a position symmetrical to that of the vent hole 28a.

The airbag 10 may be provided with a pair of slits 54 (FIG. 2) for inserting an inflator in the rear of the outer panels 26 and 28 constituting the outer surface of the communicating portion 16. As shown in FIG. 4, a rod or pipe shaped inflator 56 may be employed. The rod inflator 56 is inserted into the slits such that the inflator 56 extends through the communicating portion 16 in the width direction of the vehicle. Both ends of the inflator 56 are disposed outside of the airbag 10.

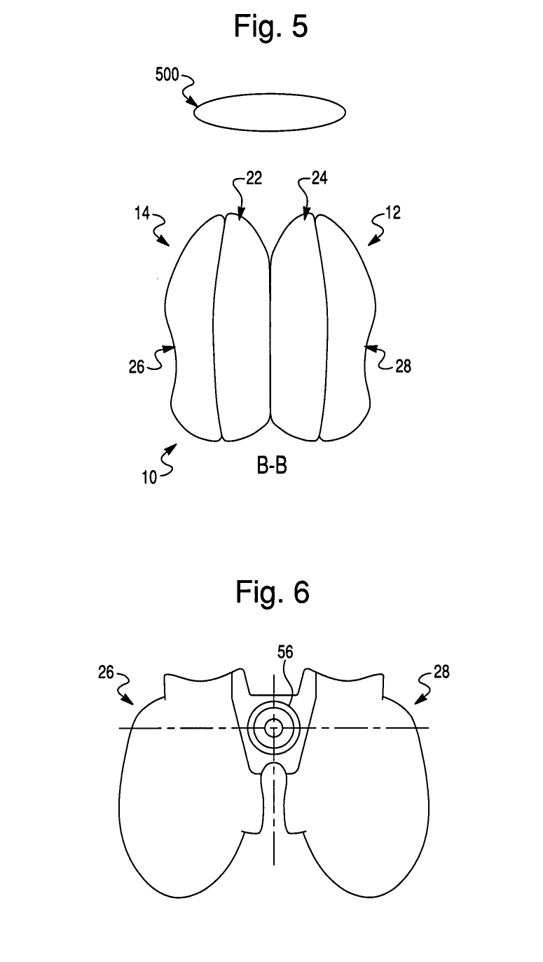

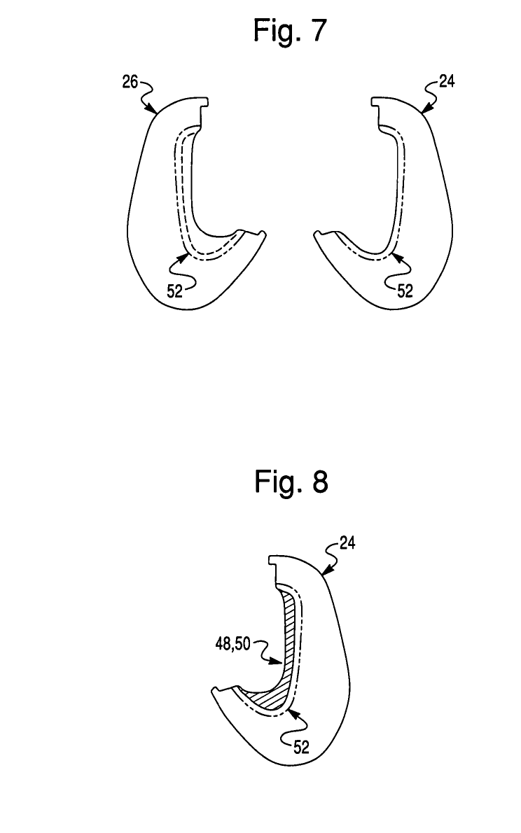

As shown in FIGS. 4 and 9-11, the seam allowances 48 and 50 are provided inwards from the stitched portion 52 of the inner panels 22 and 24 in a direction, including a vertical direction and, therefore, the inflation including at least a vertical direction element of the airbag's outer shape can be controlled with these seam allowances 48 and 50. FIGS. 5-8 illustrate various views of the airbag 10 according to one disclosed embodiment.

As a result, inflation amounts in a vertical direction are small and therefore, gas is flown actively into the airbag 10 in the right and left direction and a longitudinal direction. Since the inflation of a forward side is controlled when coming into contact with a vehicle member, gas is mainly flown toward a backward side.

Even though the inner panels 22 and 24 and outer panels 26 and 28 are not large, the airbag 10 still has a sufficient inflation size/amount on an occupant side and the airbag 10 can restrain the occupant quickly. In addition, since the airbag 10 is inflated largely in the right and left directions, the airbag can also receive the occupant's shoulders in a secure manner.

When stitching the inner panels 22 and 24 together, at least a part of the width of the seam allowances 48 and 50 is set to have 50 mm or more from an expected line to be stitched. The seam allowances 48 and 50 may be equal throughout the airbag 10 or the seam allowances 48 and 50 may be of unequal amounts throughout the airbag 10. If the equal seam allowances 48 and 50 are set to be from an expected line to be stitched, an outer shape of the airbag 10 can also be effectively controlled while saving airbag fabric. In this case, an edge shape of the stitching allowance has the same shape as an edge shape of the inner side of inner panels 22 and 24. Additionally, when the width of a part of the seam allowances 48 and 50 is set to be longer than one of the other parts and the edge shape is formed into a linear shape, the outer shape of the airbag 10 can be effectively controlled. The seam allowances 48 and 50 may be provided on both of the inner panels or only one inner panel.

When the airbag 10 is inflated, the inflation of the airbag's outer shape can be controlled with the seam allowances 48 and 50. Further, since fabric that has been wasted conventionally can also be effectively used, the amount of fabric wasted can be reduced. In addition, the entire shape of the inner panels 22 and 24 do not need to be large-sized.

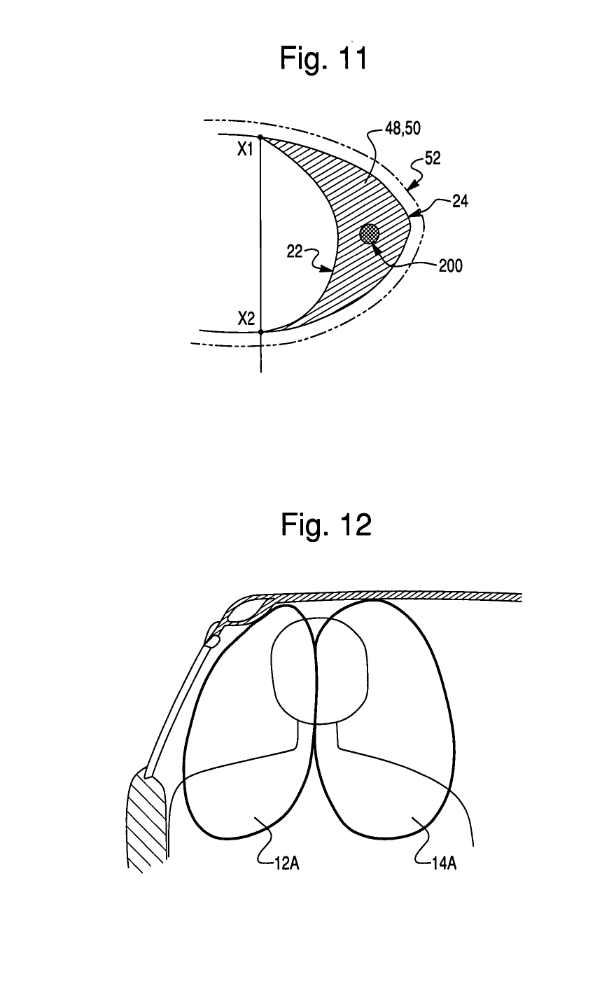

According to another disclosed embodiment as illustrated in FIG. 11, the fine line of a fabric that is a margin area or seam allowances 48 and 50 can be set parallel to a straight line connecting change points of the seam allowances 48 and 50. The straight line connecting the change points X1 and X2 of the seam allowances 48 and 50 includes at least a vertical direction element. In this situation, if the fine line is set to be in a parallel direction, not in a bias direction, it is difficult to increase (stretch) in length the seam allowances 48 and 50. Therefore, an outer shape of the airbag 10 can be effectively controlled in at least a vertical direction.

In another disclosed embodiment, a hole for a positioning pin 200 may be set in the primary seam allowance(s) when the inner panels 22 and 24 are stitched together.

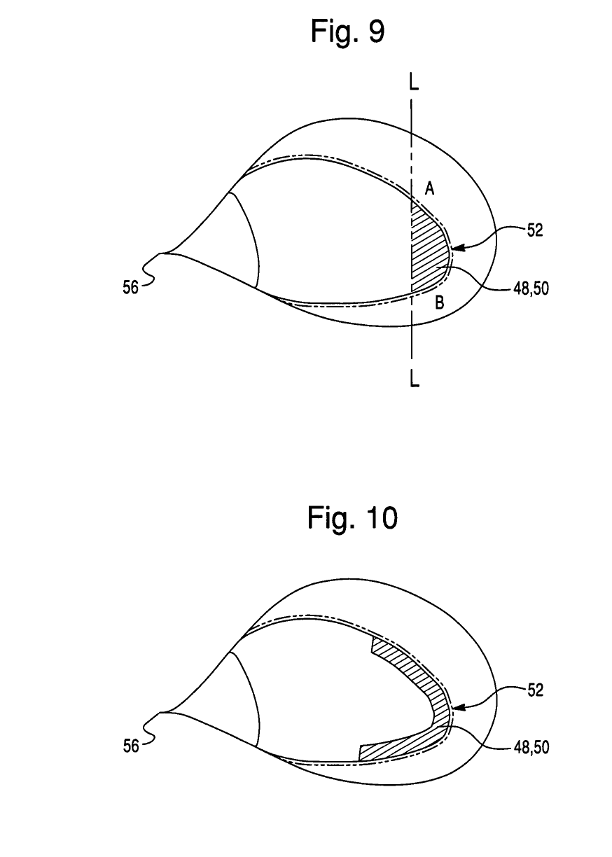

The seam allowances 48 and 50 restrain the airbag 10 from inflating in the vertical direction. According to an alternative embodiment of the present invention, if there is no tether, as illustrated in FIG. 14(b), points A and B (refer to FIG. 9), are separated and the airbag cannot be formed as a twin lobe airbag. Otherwise, as illustrated in FIG. 14(a), with a tether, points A and B are not separated and the airbag 10 is formed as a twin lobe airbag.

The airbag 10 is installed in an airbag device for protecting a vehicle occupant in the event of vehicle collision. The airbag device includes, for example, a box case with no lid (not shown) for accommodating the airbag 10, and the airbag 10 is connected with the case. Holes may be formed in the airbag 10 for inserting a fastener (not shown) such as a bolt to fix the airbag 10 to the case. Both ends of the inflator 56 are also attached to the case.

The airbag 10 is folded in the case and a cover such as a lid (not shown) is mounted on the case to cover the folded airbag 10, thus composing the airbag device. The lid is adapted to be torn by a pressing force exerted by the airbag 10 when the airbag is inflated.

The airbag device is installed in, for example, an instrument panel disposed in front of a passenger seat of a vehicle. In the event of vehicle collision, the inflator 56 ejects gas to the communicating portion 16. The gas from the inflator 56 flows in the right half airbag 12 and the left half airbag 14, thereby inflating the right half airbag 12 toward the front right of the occupant and the left half airbag 14 toward the front left of the occupant.

According to the airbag 10, the right half airbag 12 and the left half airbag 14 are inflated from the folded state. Furthermore, the right half airbag 12 and the left half airbag 14 are connected. When one of the half airbags 12 and 14 is inflated faster and the other of the half airbags 14 and 12 is inflated slower, the one half airbag facilitates the other half airbag to be inflated by pulling the other half airbag. As described above, the right half airbag 12 is connected to the left half airbag 14 with the seams 52 at the midsections thereof in the direction of inflation. Therefore, the one half airbag starts to pull the other half airbag from an early stage of inflation. Accordingly, both of the right half airbag 12 and the left half airbag 14 are inflated smoothly and substantially uniformly toward the left and right sides from the early stage of inflation.

In the completely inflated state of the airbag 10, the space 13 is formed between the distal ends of the right half airbag 12 and the left half airbag 14, and the space 13 is open toward the occupant. The inflated right half airbag 12 receives the right side of the occupant's thorax, the left half airbag 14 receives the left side of the occupant's thorax, and a portion around the occupant's breastbone faces the space 13. Therefore, when the occupant plunges into the airbag 10, a force applied to the portion around the breastbone is decreased. When the airbag 10 receives the occupant, gas in the airbag 10 is discharged through the vent holes 26a and 28a, thereby absorbing an impact.

The embodiment described above is an example of the present invention, and the present invention is not limited to the embodiments illustrated in the drawings. For example, in the embodiment, the right half airbag 12 and the left half airbag 14 are connected at the base side. Alternatively, the half airbags may be separated. More than two inflators may be provided for inflating the right half airbag and the left half airbag separately. The midsections of the left half airbag and the right half airbag may be connected by a panel, a string, a net and the like. The left half airbag and the right half airbag may have a symmetric or asymmetric shape. The left half airbag and the right half airbag may have the same capacity or different capacities.

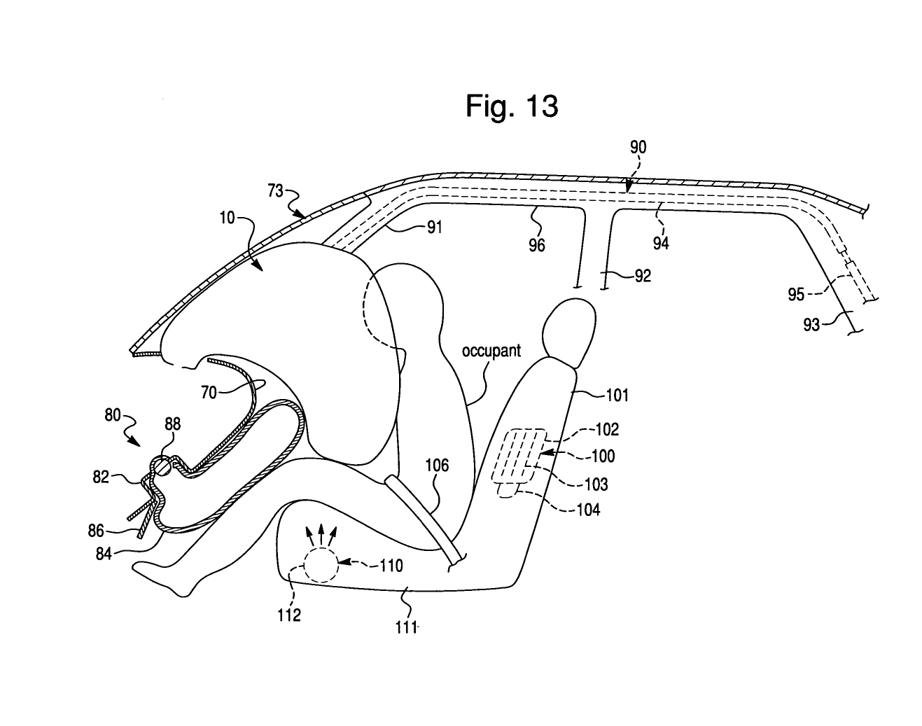

FIGS. 12 and 13 illustrate various alternative embodiments of the present invention. As shown in FIG. 12, a section of the airbag disposed at an A pillar side, i.e., a left half airbag 12A in FIG. 12, may be arranged such that an upper part of the half airbag 12A is inclined in a vehicle cabin, so that the airbag is in an appropriate position to the occupant in which, the center of the airbag is in line with the center of the occupant.

It may be arranged that the inflator is not activated upon a collision when the occupant is an infant. Also, it may be arranged that the inflator is not activated upon a collision when a child seat is mounted on a seat backward. In the present invention, it is possible to install an inflator with multi-step output or a plurality of inflators to regulate the gas pressure according to a weight of the occupant or a speed of the vehicle upon a collision.

When the vent holes 26a and 28a are located at the most preferable positions, it is possible to prevent the gas discharging through the vent holes 26a and 28a from blowing against the occupant. It is also possible to prevent the vent holes 26a and 28a from closely contacting a surface of a vehicle member such as a side window, an A pillar and the windshield 73. Accordingly, the gas is smoothly discharged through the vent holes 26a and 28a.

The vehicle provided with the airbag device of the invention may be provided with other airbag devices such as a knee airbag device or a knee protector. FIG. 13 is a longitudinal sectional view showing an example of such a vehicle. The passenger airbag device having the passenger airbag 10 of the invention is mounted on the upper surface of the instrumental panel 70. A knee airbag device 80 is mounted under the instrumental panel 70. In this embodiment, a case 82 for a knee airbag is installed in the instrumental panel 70. A knee bag 84 is retained in the case 82 in a folded state and is fixed to the case 82 with a fastener. An inflator (gas generator) 88 is installed in the case 82 for inflating the knee airbag 84. The case 82 has an opening along the instrumental panel 70, and a lid covers the opening.

When the vehicle is collided, the inflator 88 ejects gas to inflate the knee airbag 84. The inflating knee airbag 84 pushes the lid to open, and the knee airbag 84 is expanded along a front surface of the case 82 and the surrounding instrumental panel 70. The knee airbag receives the legs of the occupant for protection.

According to this disclosed embodiment, when the knee airbag 84 and the airbag 10 are fully inflated (in a case of no occupant), an upper end of the knee airbag 84 is located slightly above a lower end of the airbag 10. The vehicle is further provided with a curtain airbag device 90, a side airbag device 100 and a seat cushion bag device 110. The curtain airbag device 90 includes a curtain airbag 94 extending from an A pillar 91 to a C pillar 93 above a B pillar 92, and an inflator 95 for inflating the curtain airbag 94. The curtain airbag 94 is disposed in a long folded state from the A pillar 91 to the C pillar 93 through a roof side portion 96, and is covered with a pillar garnish and a rood trim.

When the vehicle is collided or rolled over and the inflator is activated, the curtain airbag 94 pushes the pillar garnish and the rood trim and is deployed in the vehicle cabin downwardly along the pillars 91, 92, and 93 and a side door. The expanded curtain airbag 94 receives the occupant to absorb an impact or to prevent the occupant from ejecting out of the vehicle.

The side airbag device 100 is installed in a seatback 101. The side airbag device 100 includes a side airbag 103 retained in a case 102 in a folded state and an inflator 104 for inflating the aide airbag 103. When the vehicle is collided or rolled over and the inflator 104 is activated, the side airbag 103 breaks a seatback cover and is expanded at an upper side of the occupant at a side of the door to protect the occupant. The side airbag device may be installed at a location such as a side door other than the seatback.

The seat cushion bag device 110 includes a seat cushion bag 112 disposed inside a front portion or under a lower portion of a seat cushion 111, and an inflator (not shown) for inflating the seat cushion bag. When the vehicle is collided and the inflator is activated, the seat cushion bag is inflated and pushes the seat cushion 111 upwardly. Accordingly, the front portion of the seat cushion 111 is pushed upwardly or is hardened. As a result, it is possible to prevent the occupant from moving forward. Reference numeral 106 denotes a seat belt (lap belt).

As described above, according to the present invention, the airbag and the airbag device include the left half airbag for receiving the left side of the occupant's thorax, the right half airbag for receiving the right side of the occupant's thorax, and the space disposed between the two half airbags to face the portion around a breastbone of the occupant. In the airbag and the airbag device, both of the left half airbag and the right half airbag are inflated smoothly and substantially uniformly toward the left and right sides from the early stage of inflation.

The foregoing description of preferred embodiments has been presented for purposes of illustration and description. It is not intended to be exhaustive or to limit the invention to the precise form disclosed, and modifications and variations are possible in light of the above teaching or may be acquired from practice of the invention. The embodiments were chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. An airbag for protecting an occupant, comprising:
a left half airbag having a left inner panel;
a right half airbag having a right inner panel; wherein the left and right inner panels are connected together to thereby form a gap between the half airbags;
at least one outer panel; and
a seam allowance, provided on at least one of the inner panels when the left and right inner panels are connected together,
wherein, when the airbag is inflated, the seam allowance extends into an inside part of the airbag and is configured to control inflation of the airbag in a vertical direction.

2. The airbag of claim 1, further comprising a left outer panel and a right outer panel.

3. The airbag of claim 1, wherein the inner panels are formed into an asymmetrical shape.

4. The airbag of claim 1, wherein a seam allowance is provided on both of the inner panels when the left and right inner panels are stitched together.

5. The airbag of claim 1, wherein the seam allowance is provided inward of the airbag from a stitched portion of the left and right inner panels.

6. The airbag of claim 1, wherein the seam allowance reduces inflation of the airbag in the vertical direction.

7. The airbag of claim 1, wherein the seam allowance increases inflation of the airbag in a left and right direction.

8. The airbag of claim 1, wherein the seam allowance is at least 50 mm in width.

9. The airbag of claim 1, wherein the seam allowance has a constant width.

10. The airbag of claim 1, wherein the seam allowance has a variable width.

11. The airbag of claim 1, further comprising a positioning pin in the seam allowance.

12. The airbag of claim 1, wherein the left and right airbags are inflated by a common inflator.

13. The airbag of claim 2, further comprising vent holes in the left and right outer panels.

14. The airbag of claim 13, wherein the vent holes are provided at symmetrical positions on the left and right outer panels.

15. The airbag of claim 1, wherein the left and right inner panels form a concave shape.

16. The airbag of claim 1, wherein an edge shape of a stitching portion has a same shape as an edge shape of one of the inner panels.

17. The airbag of claim 12, further comprising a communication portion for the common inflator.

18. The airbag of claim 1, wherein the seam allowance increases a depth of a central portion of the airbag.

19. An airbag module, comprising:
a left half airbag having a left inner panel;
a right half airbag having a right inner panel; wherein the left and right inner panels are connected together to thereby form a gap between the half airbags;
at least one outer panel; and
a seam allowance, provided on at least one of the inner panels when the left and right inner panels are connected together,
wherein, when the airbag is inflated, the seam allowance extends into an inside part of the airbag and is configured to control inflation of the airbag in a vertical direction; and
an inflator for providing inflation gas to the airbag.

20. A vehicle provided with an airbag device comprising an airbag and an inflator for inflating the airbag, the airbag comprising:
a left half airbag having a left inner panel;
a right half airbag having a right inner panel; wherein the left and right inner panels are connected together to thereby form a gap between the half airbags;
at least one outer panel; and
a seam allowance, provided on at least one of the inner panels when the left and right inner panels are connected together,
wherein, when the airbag is inflated, the seam allowance extends into an inside part of the airbag and controls inflation of the airbag in a vertical direction.
